(19) United States
(12) Patent Application Publication
(10) Pub. No.: US 2025/0201945 A1
(43) Pub. Date: Jun. 19, 2025

(54) BATTERY PROGNOSTIC TOOL

(71) Applicant: Caterpillar Inc., Peoria, IL (US)

(72) Inventors: Bala Vinaya KESANAKURTHY, Dunlap, IL (US); Ted Gerhardt RIMSTIDT, West Lafayette, IN (US)

(73) Assignee: Caterpillar Inc., Peoria, IL (US)

(21) Appl. No.: 18/540,755

(22) Filed: Dec. 14, 2023

(51) Int. Cl. H01M 10/42; H01M 10/48

(52) U.S. Cl. CPC H01M 10/4285; H01M 10/425; H01M 10/482; H01M 10/486; H01M 2010/4271

(57) ABSTRACT

In some implementations, a battery prognostic tool may determine one or more battery cell temperatures while a battery management system is in a non-operational state. The battery prognostic tool may compare the one or more battery cell temperatures to a thermal model associated with a thermal runaway event. The battery prognostic tool may output, while the battery management system is in the non-operational state, an alarm signal that indicates the thermal runaway event.

### TECHNICAL FIELD

The present disclosure relates generally to battery prognostics and, for example, to predicting thermal runaway events when a battery management system is in a non-operational state.

### BACKGROUND

A battery management system (BMS) monitors and manages the electrical state, health, and functionality of a battery pack, which typically includes multiple individual battery cells. A BMS may regulate charging and discharging processes, balance the charge across cells, and protect the battery from operating outside operating parameters. The BMS may continuously monitor parameters such as voltage, current, and temperature of each cell, as well as the temperature of the overall battery pack. By doing so, the BMS may prevent conditions that could lead to reduced battery life, inefficiencies, overcharging, deep discharging, overheating, or short-circuiting.

The BMS may seek to prevent a thermal runaway event. A thermal runaway is a self-sustaining, exothermic reaction that can occur within a battery cell, leading to a rapid increase in temperature and potential cell failure. A thermal runaway typically initiates when a battery is subjected to conditions like overcharging, short-circuiting, physical damage, or external heat, which cause an increase in the internal temperature of the cell. This temperature rise can lead to the breakdown of internal battery materials and the generation of heat, further accelerating the temperature increase. If left unchecked, thermal runaway can result in the degradation of the battery's electrolyte and other components, potentially leading to failure. The susceptibility of a battery to thermal runaway is influenced by its chemistry, design, and state of health. Predicting thermal runaway events can be challenging because of the complexity of the factors that may result in a thermal runaway.

China Pat. Pub. No. 114069078A (the '078 publication) discloses a lithium battery thermal runaway early warning system using a passive trigger module to detect whether the temperature of the battery module in the lithium battery exceeds a preset temperature or not so as to judge whether the thermal runaway fault occurs in the battery module. If the thermal runaway fault occurs, the early warning is carried out through the early warning unit in the early warning control module, so that the runaway early warning of the lithium battery can be effectively carried out, and the control unit controls the protection module to carry out thermal runaway protection so as to ensure the use safety of the lithium battery.

The '078 publication, however, cannot detect thermal runaway when the BMS is in a non-operating mode. Therefore, if the device using the lithium battery thermal runaway early warning system of the '078 publication is turned off, or if a BMS of the '078 publication has failed, the lithium battery thermal runaway early warning system will not be able to monitor for thermal runaway events.

The battery prognostic tool of the present disclosure solves one or more of the problems set forth above and/or other problems in the art.

### SUMMARY

A battery prognostic tool may include one or more memories; and one or more processors, communicatively coupled to the one or more memories, configured to: predict, while a battery management system is in a non-operational state, a thermal runaway event in accordance with one or more battery cell temperatures and a thermal model; and output, while the battery management system is in the non-operational state, an alarm signal indicating the thermal runaway event.

A method may include determining one or more battery cell temperatures while a battery management system is in a non-operational state; comparing the one or more battery cell temperatures to a thermal model associated with a thermal runaway event; and outputting, while the battery management system is in the non-operational state, an alarm signal that indicates the thermal runaway event.

A machine may include: a plurality of battery cells; a battery management system configured to operate in an operational state and a non-operational state, and configured to control operation of the plurality of battery cells while operating in the operational state; and a battery prognostic tool configured to predict, while the battery management system is in the non-operational state, a thermal runaway event in accordance with one or more battery cell temperatures and a thermal model.

### BRIEF DESCRIPTION OF THE DRAWINGS

FIG. 1 is a diagram of an example battery pack.

FIG. 2 is a diagram of an example battery prognostic tool in communication with a battery management system.

FIG. 3 is a flowchart of an example process associated with predicting thermal runaway events.

### DETAILED DESCRIPTION

This disclosure relates to a battery prognostic tool, which is applicable to a battery module that provides power to a machine, such as a machine that performs an operation associated with an industry, such as mining, construction, farming, transportation, or any other industry. For example, the machine may be an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples. As used herein, “battery cell,” “battery,” and “cell” may be used interchangeably.

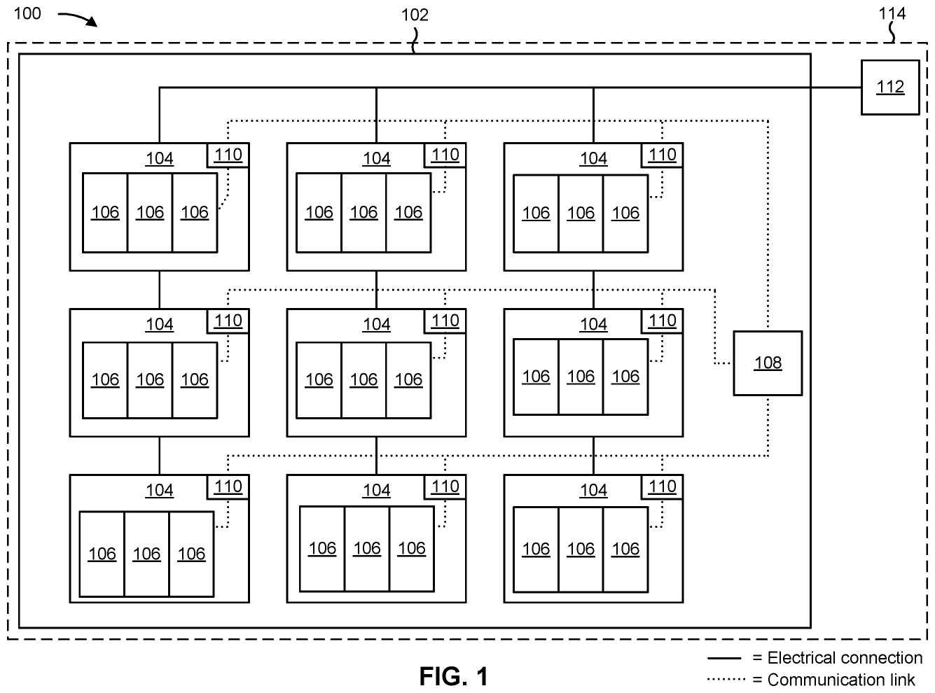

FIG. 1 is a diagram of an example battery pack 100. The battery pack 100 may include a battery pack housing 102, one or more battery modules 104, and one or more battery cells 106. The battery pack 100 includes a battery pack controller 108 (sometimes called a “battery management system (BMS)”) associated with storing information and/or controlling one or more operations associated with the battery pack 100. Each battery module 104 includes a module controller 110 associated with storing information and/or controlling one or more operations associated with the battery module 104.

The battery pack 100 may be associated with a component 112. The component 112 may be powered by the battery pack 100. For example, the component 112 can be a load that consumes energy provided by the battery pack 100, such as an electric motor, among other examples. As another example, the component 112 provides energy to the battery pack 100 (e.g., to be stored by the battery cells 106). In such examples, the component 112 may be a power generator, a solar energy system, and/or a wind energy system, among other examples. A machine 114 may include the battery pack 100 and the component 112 (e.g., an electric motor). For example, the battery pack 100 (e.g., one or more battery modules 104 thereof) may be electrically connected to the component 112. The machine 114 may be an electric vehicle (e.g., a car, a train, or a boat) or an electric work machine.

The battery pack housing 102 may include metal shielding (e.g., steel, aluminum, or the like) to protect elements (e.g., battery modules 104, battery cells 106, the battery pack controller 108, the module controllers 110, wires, circuit boards, or the like) positioned within battery pack housing 102. Each battery module 104 includes one or more (e.g., a plurality of) battery cells 106 (e.g., positioned within a housing of the battery module 104). Battery cells 106 may be connected in series and/or in parallel within the battery module 104 (e.g., via terminal-to-busbar welds). Each battery cell 106 is associated with a chemistry type. The chemistry type may include lithium ion (Li-ion), nickel-metal hydride (NiMH), nickel cadmium (NiCd), lithium ion polymer (Li-ion polymer), lithium iron phosphate (LFP), and/or nickel manganese cobalt (NMC), among other examples.

The battery modules 104 may be arranged within the battery pack 100 in one or more strings. For example, the battery modules 104 are connected via electrical connections, as shown in FIG. 1. The electrical connections may be removable, such as via bolts and/or nuts at one or more terminals on housings of the battery modules 104. The battery modules 104 may be connected in series and/or in parallel. For example, a number of battery modules 104 may be connected in series to provide a particular voltage (e.g., to the component 112). Alternatively, a number of battery modules 104 may be connected in parallel to increase a current and/or a power output of the battery pack 100. The number of battery cells 106 included in each battery module 104, and the number of battery modules 104 included in the battery pack 100 (e.g., and the relative serial and/or parallel connections of the battery cells 106 and/or the battery modules 104) may be associated with the required output power and an intended use of the battery pack 100. For example, any number of battery cells 106 can be included in a battery module 104. Similarly, any number of battery modules 104 can be included in the battery pack 100.

The battery pack controller 108 is communicatively connected (e.g., via a communication link) to each module controller 110. The battery pack controller 108 may be associated with receiving, generating, storing, processing, providing, and/or routing information associated with the battery pack 100. The battery pack controller 108 may also be referred to as a battery pack management device or system. The battery pack controller 108 may communicate with the component 112 and/or a controller of the component 112, may control a start-up and/or shut-down procedure of the battery pack 100, may monitor a current and/or voltage of a string (e.g., of battery modules 104), and/or may monitor and/or control a current and/or voltage provided by the battery pack 100, among other examples. A module controller 110 may be associated with receiving, generating, storing, processing, providing, and/or routing information associated with a battery module 104. The module controller 110 may communicate with the battery pack controller 108.

The battery pack controller 108 and/or a module controller 110 may be associated with monitoring and/or determining a state of charge (SOC), a state of health (SOH), a depth of discharge (DOD), an output voltage, a temperature, and/or an internal resistance and impedance, among other examples, associated with a battery module 104 and/or associated with the battery pack 100. Additionally, or alternatively, the battery pack controller 108 and/or the module controller 110 may be associated with monitoring, controlling, and/or reporting one or more parameters associated with battery cells 106. The one or more parameters may include cell voltages, temperatures, chemistry types, a cell energy throughput, a cell internal resistance, and/or a quantity of charge-discharge cycles of a battery module 104, among other examples.

As indicated above, FIG. 1 is provided as an example. Other examples may differ from what is described with regard to FIG. 1.

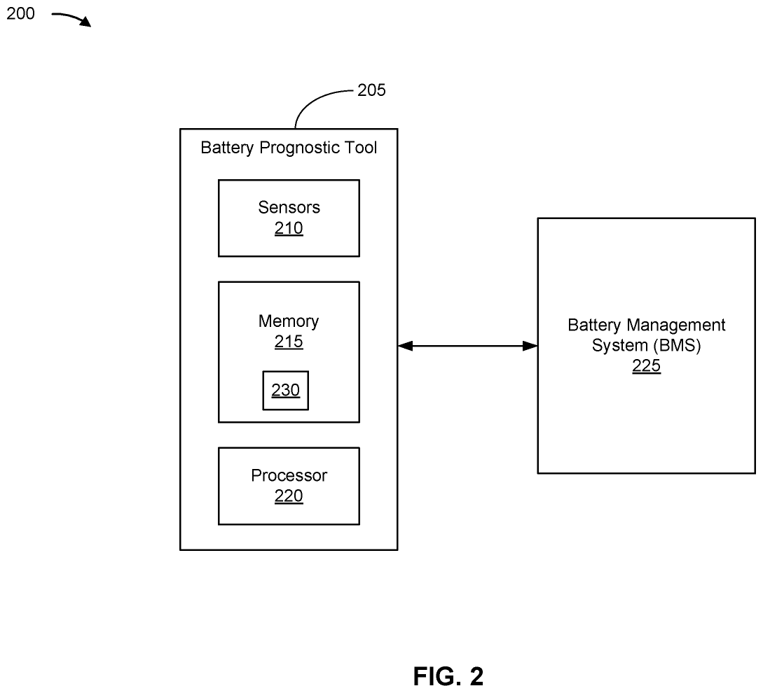

FIG. 2 is a diagram of an example implementation 200 associated with a battery prognostic tool 205 that includes one or more sensors 210, one or more memories (collectively, the “memory”) 215, and one or more processors (collectively, the “processor”) 220. The battery prognostic tool 205 may be in communication with a battery management system (BMS) 225. The BMS may be included in the battery pack controller 108 and may operate in an operational state and a non-operational state. For example, when in the operational state, the BMS may perform the functions discussed above with respect to the battery pack controller 108. The BMS may be in the non-operational state when the machine is turned off or when the BMS has experienced a failure. These devices are described in more detail in connection with FIG. 1 and FIG. 2.

The sensors 210 may include one or more temperature sensors configured to measure a temperature of one or more battery cells (e.g., battery cells 106). Each temperature sensor may be disposed on a battery cell for measuring a temperature of the battery cell. The sensors 210 may output signals (e.g., cell temperature signals) indicating the temperature of each battery cell (i.e., each temperature signal may be associated with a temperature of a single battery cell), a temperature of a jellyroll (e.g., rolled layering of an anode, a cathode, and a separator) of the battery cell, and/or a combination thereof, among other examples.

The memory 215 may store instructions and/or information that can be accessed by the processor 220. For example, the memory 215 may store a thermal model 230, the battery cell temperatures output by the sensors 210, the operating state of the BMS, instructions for determining one or more battery cell temperatures, instructions for comparing the one or more battery cell temperatures to the thermal model 230, instructions for measuring the battery cell temperatures, instructions for predicting a thermal runaway event, instructions for determining the operating state of the BMS, and/or a combination thereof, among other examples.

The thermal model 230 stored in the memory 215 may represent heat propagation across battery cells. For example, the thermal model 230 may indicate a threshold at which heat from one cell will spread to another cell (i.e., cell-to-cell heat propagation), which may result in a thermal runaway event. The thermal runaway event may include an abusive venting event (e.g., high pressure that causes the release of gases or electrolytes from the battery cell), and the abusive venting event may be caused by cell-to-cell heat propagation.

The processor 220 may be configured to access the information and/or execute instructions stored in the memory 215. For example, the processor 220 may be configured to determine the operating state of the BMS, determine the temperature of one or more of the battery cells, and predict, while the battery management system is in the non-operational state, the thermal runaway event in accordance with the thermal model 230 and the battery cell temperatures. When the BMS is in a non-operational state, the processor 220 may be configured to receive one or more of the cell temperature signals output by the sensors 210 and compare the temperatures of each of the battery cells or jellyrolls to the threshold in the thermal model 230. If the temperature of one or more of the battery cells or jellyrolls exceeds the threshold, the processor 220 may be configured to output an alarm signal. The alarm signal may indicate that the thermal runaway event is imminent.

Because the battery prognostic tool 205 can detect thermal runaway events and output the alert signal when the BMS is in a non-operational state, a user of the machine may be alerted to the thermal runaway event even if the BMS has failed, was disabled, or was turned off. Moreover, by detecting the thermal runaway event at the battery cell level, the alarm signal may be presented to the user early enough to stop the thermal runaway event from progressing, which could save the battery module from malfunctioning and/or failure.

As indicated above, FIG. 2 is provided as an example. Other examples may differ from what is described with regard to FIG. 2.

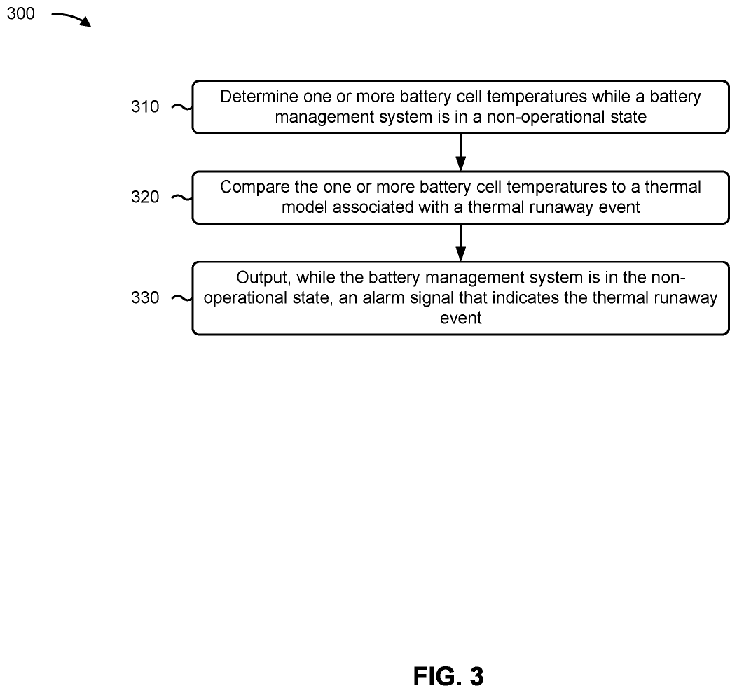

FIG. 3 is a flowchart of an example process 300 associated with predicting thermal runaway events. One or more process blocks of FIG. 3 may be performed by a battery prognostic tool (e.g., battery prognostic tool 205). Additionally, or alternatively, one or more process blocks of FIG. 3 may be performed by another device or a group of devices separate from or including the battery prognostic tool, such as another device or component that is internal or external to the battery prognostic tool.

As shown in FIG. 3, process 300 may include determining one or more battery cell temperatures while a battery management system is in a non-operational state (block 310). For example, the battery prognostic tool may determine one or more battery cell temperatures while a battery management system is in a non-operational state, as described above. Determining the one or more battery cell temperatures may include measuring the one or more battery cell temperatures. Determining the one or more battery cell temperatures may include receiving one or more cell temperature signals. Each of the one or more battery cell temperatures may indicate a temperature of a jellyroll within a battery cell.

As further shown in FIG. 3, process 300 may include comparing the one or more battery cell temperatures to a thermal model (e.g., thermal model 230) associated with a thermal runaway event (block 320). For example, the battery prognostic tool may compare the one or more battery cell temperatures to a thermal model associated with a thermal runaway event, as described above.

As further shown in FIG. 3, process 300 may include outputting, while the battery management system is in the non-operational state, an alarm signal that indicates the thermal runaway event (block 330). For example, the battery prognostic tool may output, while the battery management system is in the non-operational state, an alarm signal that indicates the thermal runaway event, as described above.

As discussed above with respect to FIG. 2, the thermal model may include a threshold and the alarm signal may indicate that at least one of the one or more battery cell temperatures exceeds the threshold.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

### INDUSTRIAL APPLICABILITY

The battery prognostic tool described herein may be used to predict thermal runaway events for a battery module even when the BMS is in a non-operational state. Thermal runaway events can occur even when a machine is not operating. For example, a thermal runaway event could occur due to the ambient air temperature being too high, a structural deformity (e.g., an object colliding with the battery pack), or other situations not associated with the operation of the machine. The thermal runaway event may go unnoticed if the machine (and therefore the BMS) is not operational at the time the thermal runaway event starts. By alerting a user to potential thermal runaway events (e.g., a temperature increase at the battery cell level) early, tool allows the user to intervene and possibly prevent the thermal runaway event and salvage the battery module.

What is claimed is:

1. A battery prognostic tool, comprising:
one or more memories; and
one or more processors, communicatively coupled to the one or more memories, configured to:
predict, while a battery management system is in a non-operational state, a thermal runaway event in accordance with one or more battery cell temperatures and a thermal model; and
output, while the battery management system is in the non-operational state, an alarm signal indicating the thermal runaway event.

2. The battery prognostic tool of claim 1, wherein each of the one or more battery cell temperatures is associated with a single battery cell.

3. The battery prognostic tool of claim 1, further comprising one or more temperature sensors configured to output one or more temperature signals.

4. The battery prognostic tool of claim 3, wherein the one or more processors are further configured to receive one or more cell temperature signals output by the one or more temperature sensors.

5. The battery prognostic tool of claim 4, wherein each of the one or more cell temperature signals indicates a temperature of a battery cell.

6. The battery prognostic tool of claim 4, wherein each of the one or more cell temperature signals indicates a temperature of a jellyroll within a battery cell.

7. The battery prognostic tool of claim 1, wherein the thermal model includes a threshold.

8. The battery prognostic tool of claim 7, wherein the alarm signal indicates that at least one of the one or more battery cell temperatures exceeds the threshold.

9. A method, comprising:
determining one or more battery cell temperatures while a battery management system is in a non-operational state;
comparing the one or more battery cell temperatures to a thermal model associated with a thermal runaway event; and
outputting, while the battery management system is in the non-operational state, an alarm signal that indicates the thermal runaway event.

10. The method of claim 9, wherein determining the one or more battery cell temperatures includes measuring the one or more battery cell temperatures.

11. The method of claim 9, wherein determining the one or more battery cell temperatures includes receiving one or more cell temperature signals.

12. The method of claim 9, wherein each of the one or more battery cell temperatures indicates a temperature of a jellyroll within a battery cell.

13. The method of claim 9, wherein the thermal model includes a threshold.

14. The method of claim 13, wherein the alarm signal indicates that at least one of the one or more battery cell temperatures exceeds the threshold.

15. A machine, comprising:
a plurality of battery cells;
a battery management system configured to operate in an operational state and a non-operational state, and configured to control operation of the plurality of battery cells while operating in the operational state; and
a battery prognostic tool configured to predict, while the battery management system is in the non-operational state, a thermal runaway event in accordance with one or more battery cell temperatures and a thermal model.

16. The machine of claim 15, wherein the battery prognostic tool is further configured to output, while the battery management system is in the non-operational state, an alarm signal indicating the thermal runaway event.

17. The machine of claim 15, wherein the thermal runaway event includes an abusive venting event.

18. The machine of claim 15, wherein the thermal model includes a model for cell-to-cell heat propagation of the plurality of battery cells.

19. The machine of claim 15, further comprising one or more temperature sensors configured to output one or more temperature signals.

20. The machine of claim 19, wherein the battery prognostic tool is further configured to receive one or more cell temperature signals output by the one or more temperature sensors.
